(19) United States
(12) Patent Application Publication
(10) Pub. No.: US 2015/0169744 A1
(43) Pub. Date: Jun. 18, 2015

(54) Selecting Diverse, Relevant Content From Multiple Content Feeds

(71) Applicant: Flipboard, Inc., Palo Alto, CA (US)

(72) Inventors: Andrew David Walkingshaw, San Francisco, CA (US); Boris Lev Aleksandrovsky, Berkeley, CA (US); Xiaoyu Suzanne Fei, Palo Alto, CA (US); Evan R. Doll, Menlo Park, CA (US); Marcos Weskamp, Palo Alto, CA (US); Didier Hilhorst, San Francisco, CA (US); Michael S. McCue, Palo Alto, CA (US); Joshua Quittner, Mill Valley, CA (US); Todd Lappin, San Francisco, CA (US); Eugene Wei, San Francisco, CA (US); Charles Hugo Ying, San Mateo, CA (US); Christopher Hamamoto Partridge, San Francisco, CA (US)

(21) Appl. No.: 14/567,840

(22) Filed: Dec. 11, 2014

Related U.S. Application Data
(60) Provisional application No. 61/915,440, filed on Dec. 12, 2013.

(51) Int. Cl. G06F 17/30

(52) U.S. Cl. CPC G06F 17/30705; G06F 17/3097

(57) ABSTRACT

A digital magazine server creates cover pages identifying relevant content items relevant to a user. Candidate feeds of content items are identified from various sources, such as user-defined sections of content items, social networking systems, external content providers, and recommended content. The digital magazine server retrieves content items from the candidate feeds and generates clusters including retrieved content items based at least in part on the content elements contained in the content items. The content items in various clusters are scored, and one or more content items are selected from each cluster. The selected content items are placed in a consolidated feed, which is used to create a cover page describing a digital magazine for presentation to a digital magazine server user.

### CROSS-REFERENCE TO RELATED APPLICATION

This application claims the benefit of U.S. Provisional Application No. 61/915,440, filed Dec. 12, 2013, which is hereby incorporated by reference in its entirety.

### BACKGROUND

This invention generally relates to recommending content to a user of a digital magazine server, and more specifically to recommend a diverse set of content to that user.

Digital distribution channels disseminate content including text, images, audio, links, videos, and interactive media (e.g., games, collaborative content). Although users of online systems can access more content than before, the broad selection available can overwhelm users. Various conventional techniques for recommending content to users are based on previous interactions by users with an online system, such as a social networking system. However, these conventional techniques often fail to present users with a wide variety of content. Often, these conventional techniques fail to present content likely to be of interest to the user but that has not been accessed by the user via the online system. Additionally, while some online systems manually curate cover pages with content of interest to a user, these manually curated cover pages often fail to accommodate the diverging interests of a wide group of users.

### SUMMARY

A digital magazine server retrieves content from one or more sources and generates a personalized, customizable digital magazine for a user based on the retrieved content. The digital magazine server presents customized cover pages, which include information describing content items retrieved for presentation to users. To create a customized cover page, the digital magazine server identifies content items from various candidate feeds. A candidate feed includes content items selected by a user, content items recommended by the digital magazine server based on the user's inferred interests, content items retrieved from social networking systems associated with the user, content items retrieved from sources external to the digital magazine server, or content items targeted to the user based on user characteristics. Candidate content items are retrieved from the candidate feeds, sorted into groups of similar content items, and ranked within the groups of similar content items. Content items having at least a threshold position in the group-specific ranking are selected from one or more of the groups of similar content items. Content items may be selected from a group based on relevance of the content items to the user or similarity between a content item and other content items in the group. The selected content items are included in a consolidated feed used to generate a cover page presented to the user. The cover page includes information describing content items from the consolidated feed. Sorting content items into various groups and selecting content items from the various groups ensures that the cover page presents information describing a diverse range of content items.

### BRIEF DESCRIPTION OF THE DRAWINGS

FIG. 1 is a block diagram of a system environment in which a digital magazine server operates, in accordance with an embodiment of the invention.

FIG. 2 is a block diagram of a digital magazine server, in accordance with an embodiment of the invention.

FIG. 3 is an example of presentation of content items in a digital magazine using a page template, in accordance with an embodiment of the invention.

FIG. 4 is a flowchart of a method for selecting diverse content items for inclusion in a cover page of a digital magazine, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

A digital magazine server retrieves content from one or more sources and generates a personalized, customizable digital magazine for a user based on the retrieved content. The generated digital magazine is retrieved by a digital magazine application executing on a computing device (such as a mobile communication device, tablet, computer, or any other suitable computing system) and presented to the user. For example, based on selections made by the user and/or on behalf of the user, the digital server application generates a digital magazine including one or more sections including content items retrieved from a number of sources and personalized for the user. The generated digital magazine allows the user to more easily consume content that interests and inspires the user by presenting content items in an easily navigable interface via a computing device.

The digital magazine may be organized into a number of sections that each includes content having a common characteristic (e.g., content obtained from a particular source, content having particular key words, content associated with particular topics). For example, a section of the digital magazine includes articles from an online news source (such as a website for a news organization), another section includes articles from a third-party-curated collection of content associated with a particular topic (e.g., a technology compilation), and an additional section includes content obtained from one or more accounts associated with the user and maintained by one or more social networking systems. For purposes of illustration, content included in a section is referred to herein as “content items” or “articles,” which may include textual articles, pictures, videos, products for sale, user-generated content (e.g., content posted on a social networking system), advertisements, and any other types of content capable of display within the context of a digital magazine.

### System Architecture

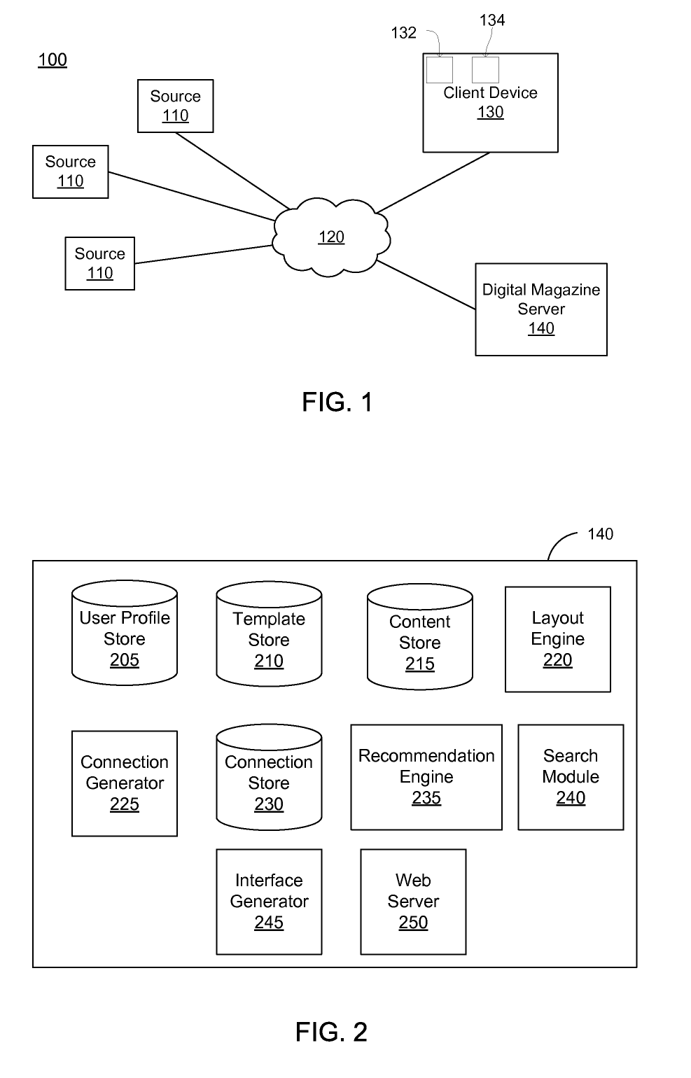

FIG. 1 is a block diagram of a system environment 100 for a digital magazine server 140. The system environment 100 shown by FIG. 1 comprises one or more sources 110, a network 120, a client device 130, and the digital magazine server 140. In alternative configurations, different and/or additional components may be included in the system environment 100. The embodiments described herein can be adapted to online systems that are not digital magazine severs 140.

A source 110 is a computing system capable of providing various types of content to a client device 130. Examples of content provided by a source 110 include text, images, video, or audio on web pages, web feeds, social networking information, messages, or other suitable data. Additional examples of content include user-generated content such as blogs, tweets, shared images, video or audio, social networking posts, and social networking status updates. Content provided by a source 110 may be received from a publisher (e.g., stories about news events, product information, entertainment, or educational material) and distributed by the source 110, or a source 110 may be a publisher of content it generates. For convenience, content from a source, regardless of its composition, may be referred to herein as an “article,” a “content item,” or as “content.” A content item may include various types of content elements such as text, images, video, interactive media, links, and a combination thereof.

The sources 110 communicate with the client device 130 and the digital magazine server 140 via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.1, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

The client device 130 is one or more computing devices capable of receiving user input as well as transmitting and/or receiving data via the network 120. In one embodiment, the client device 110 is a conventional computer system, such as a desktop or a laptop computer. Alternatively, the client device 130 may be a device having computer functionality, such as a personal digital assistant (PDA), a mobile telephone, a smartphone or another suitable device. In one embodiment, the client device 130 executes an application allowing a user of the client device 110 to interact with the digital magazine server 140. For example, an application executing on the client device 130 communicates instructions or requests for content items to the digital magazine server 140 to modify content presented to a user of the client device 130. As another example, the client device 130 executes a browser that receives pages from the digital magazine server 140 and presents the pages to a user of the client device 130. In another embodiment, the client device 130 interacts with the digital magazine server 140 through an application programming interface (API) running on a native operating system of the client device 110, such as IOS® or ANDROID™. While FIG. 1 shows a single client device 130, in various embodiments, any number of client devices 130 may communicate with the digital magazine server 140. Different client devices may have different characteristics such as different processing capabilities, different connection speeds with the digital magazine server 140 over the network 120, and different device types (e.g., make, manufacture, version).

A display device 132 included in the client device 130 presents content items to a user of the client device 130. Examples of the display device 132 include a liquid crystal display (LCD), an organic light emitting diode (OLED) display, an active matrix liquid crystal display (AMLCD), or any other suitable device. Different client devices 130 may have display devices 132 with different characteristics. For example, different client devices 130 have display devices 132 with different display areas, different resolutions, different aspect ratios, different display dimensions, or differences in other characteristics.

One or more input devices 134 included in the client device 130 receive input from the user. Different input devices 134 may be included in the client device 130. For example, the client device 130 includes a touch-sensitive display for receiving input data, commands, or information from a user. Using a touch-sensitive display allows the client device 130 to combine the display device 132 and an input device 134, simplifying user interaction with presented content items. In other embodiments, the client device 130 may include a keyboard, a trackpad, a mouse, or any other device capable of receiving input from a user. Additionally, the client device may include multiple input devices 134 in some embodiments. Inputs received via the input device 134 may be processed by a digital magazine application associated with the digital magazine server 140 and executing on the client device 130 to allow a client device user to interact with content items presented by the digital magazine server 140.

The digital magazine server 140 receives content items from one or more sources 110, generates pages in a digital magazine by processing the received content, and provides the pages to the client device 130. As further described below in conjunction with FIG. 22, the digital magazine server 140 generates one or more pages for presentation to a user based on content items obtained from one or more sources 110 and information describing organization and presentation of content items. For example, the digital magazine server 140 determines a page layout specifying positioning of content items relative to each other based on information associated with a user and generates a page including the content items arranged according to the determined layout for presentation to the user via the client device 130. This allows the user to access content items via the client device 130 in a format that enhances the user's interaction with and consumption of the content items. For example, the digital magazine server 140 provides a user with content items in a format similar to the format used by print magazines. By presenting content items in a format similar to a print magazine, the digital magazine server 140 allows a user to interact with content items from multiple sources 110 via the client device 130 with less inconvenience from horizontally or vertically scrolling to access various content items.

FIG. 2 is a block diagram of an architecture of the digital magazine server 140. The digital magazine server 140 shown in FIG. 2 includes a user profile store 205, a template store 210, a content store 215, a layout engine 220, a connection generator 225, a connection store 230, a recommendation engine 235, a search module 240, an interface generator 245, and a web server 250. In other embodiments, the digital magazine server 140 may include additional, fewer, or different components for various applications. Conventional components such as network interfaces, security functions, load balancers, failover servers, management and network operations consoles, and the like are not shown so as to not obscure the details of the system architecture.

Each user of the digital magazine server 140 is associated with a user profile, which is stored in the user profile store 205. A user profile includes declarative information about the user that was explicitly shared by the user and may also include profile information inferred by the digital magazine server 140. In one embodiment, a user profile includes multiple data fields, each describing one or more attributes of the corresponding social networking system user. Examples of information stored in a user profile include biographic, demographic (e.g., age, gender, occupation, education, socioeconomic status), and other types of descriptive information, such as gender, hobbies or preferences, location (e.g., residence, birthplace, check-in locations), or other suitable information. The user profile store 205 may also include information for accessing one or more social networking systems or other types of sources (e.g., a user name, a password, an access code) that a user has authorized the digital magazine server 140 to access. A user profile in the user profile store 205 also includes data describing interactions by a corresponding user with content items presented by the digital magazine server 140. For example, a user profile includes a content item identifier, a description of an interaction with the content item corresponding to the content item identifier, and a time when the interaction occurred. Content items a user previously interacted with may be retrieved by the digital magazine server 140 using the content item identifiers in the user's user profile, allowing the digital magazine server 140 to recommend content items to the user based on content items with which the user previously interacted.

While user profiles in the user profile store 205 are frequently associated with individuals, allowing individuals to provide and receive content items via the digital magazine server 140, user profiles may also be stored for entities such as businesses or organizations. This allows an entity to provide or access content items via the digital magazine server 140. An entity may post information about itself, about its products or provide other content items associated with the entity to users of the digital magazine server 140. For example, users of the digital magazine server 140 may receive a digital magazine or section including content items associated with an entity via the digital magazine server 140.

The template store 210 includes page templates each describing a spatial arrangement (“layout”) of content items relative to each other on a page for presentation by a client device 130. A page template includes one or more slots, each configured to present one or more content items. In some embodiments, slots in a page template may be configured to present a particular type of content item or to present a content item having one or more specified characteristics. For example, a slot in a page template is configured to present an image while another slot in the page template is configured to present text data. Each slot has a size (e.g., small, medium, or large) and an aspect ratio. One or more page templates may be associated with types of client devices 130, allowing content items to be presented in different relative locations and with different sizes when the content items are viewed using different client devices 130. Additionally, page templates may be associated with sources 110, allowing a 110 to specify the format of pages presenting content items received from the 110. For example, an online retailer is associated with a page template to allow the online retailer to present content items via the digital magazine server 140 with a specific organization.

The content store 215 stores objects that represent various types of content. For example, the content store 215 stores content items received from one or more sources 110 within a threshold time of a current time. Examples of content items stored by the content store 215 include a page post, a status update, a photograph, a video, a link, an article, video data, audio data, a check-in event at a location, or any other type of content. A user may specify a section including content items having a common characteristic, and the common characteristic is stored in the content 215 store along with an association with the user profile or the user specifying the section. In one embodiment, the content store 215 includes information identifying candidate content items for recommendation to a user. In one embodiment, the content store 215 may also store characteristic vectors representing a combination of interests for a user or clusters of interests or content items for a user determined by the recommendation engine 235.

The layout engine 220 retrieves content items from one or more sources 110 or from the content store 215 and generates a page including the content items based on a page template from the template store 210. Based on the retrieved content items, the layout engine 220 may identify candidate page templates from the template store 210, score the candidate page templates based on characteristics of the slots in different candidate page templates and based on characteristics of the content items. Based on the scores associated with candidate page templates, the layout engine 220 selects a page template and associates the retrieved content items with one or more slots to generate a page where the retrieved content items are presented relative to each other and sized based on their associated slots. When associating a content item with a slot, the layout engine 220 may associate the content item with a slot configured to present a specific type of content item or to present content items having one or more specified characteristics.

The connection generator 225 monitors interactions between users and content items presented by the digital magazine server 140. Based on the interactions, the connection generator 225 determines connections between various content items, connections between users and content items, or connections between users of the digital magazine server 140. For example, the connection generator 225 identifies when users of the digital magazine server 140 provide feedback about a content item, access a content item, share a content item with other users, or perform other actions with content items. In some embodiments, the connection generator 225 retrieves data describing user interaction with content items from the user's user profile in the user profile store 205. Alternatively, user interactions with content items are communicated to the connection generator 225 when the interactions are received by the digital magazine server 140. The connection generator 225 may account for temporal information associated with user interactions with content items. For example, the connection generator 225 identifies user interactions with a content item within a specified time interval or applies a decay factor to identified user interactions based on times associated with interactions. The connection generator 225 generates a connection between a user and a content item if the user's interactions with the content item satisfy one or more criteria. In one embodiment, the connection generator 225 determines one or more weights specifying a strength of the connection between the user and the content item based on user interactions with the content item that satisfy one or more criteria.

If multiple content items are connected to a user, the connection generator 225 establishes implicit connections between each of the content items connected to the user. In one embodiment, the connection generator 225 maintains a user content graph identifying the implicit connections between content items connected to a user. In one embodiment, weights associated with connections between a user and content items are used to determine weights associated with various implicit connections between content items. User content graphs for multiple users of the digital magazine server 140 are combined to generate a global content graph describing connections between various content items provided by the digital magazine server 140 based on user interactions with various content items. For example, the global content graph is generated by combining user content graphs based on mutual connections between various content items in user content graphs.

In one embodiment, the connection generator 225 generates an adjacency matrix from the global content graph or from multiple user content graphs and stores the adjacency matrix in the connection store 230. The adjacency matrix describes connections between content items. For example, the adjacency matrix includes identifiers of content items and weights representing the strength or closeness of connections between content items based on the global content graph. As an example, the weights indicate a degree of similarity in subject matter or similarity of other characteristics associated with various content items. In other embodiments, the connection store 230 includes various adjacency matrices determined from various user content graphs; the adjacency matrices may be analyzed to generate an overall adjacency matrix for content items provided by the digital magazine server 140. Graph analysis techniques may be applied to the adjacency matrix to rank content items, to recommend content items to a user, or to otherwise analyze relationships between content items.

In addition to identifying connections between content items, the connection generator 225 may also determine a social proximity between users of the digital magazine server 140 based on interactions between users and content items. The digital magazine server 140 determines social proximity, or “social distance,” between users using a variety of techniques. For example, the digital magazine server 140 analyzes additional users connected to each of two users of the digital magazine server 140 within a social networking system to determine the social proximity of the two users. In another example, the digital magazine server 140 determines social proximity between a first and a second user by analyzing the first user's interactions with content items posted by the second user, whether the content item is posted using the digital magazine server 140 or on another social networking system. In one embodiment, the connection generator 225 determines a connection confidence value between a user and an additional user of the digital magazine server 140 based on the user's and the additional user's common interactions with particular content items. The connection confidence value may be a numerical score representing a measure of closeness between the user and the additional user. For example, a larger connection confidence value indicates a greater similarity between the user and the additional user. In one embodiment, if a user has at least a threshold connection confidence value with another user, the digital magazine server 140 stores a connection between the user and the additional user in the connection store 230.

Using data from the connection store 230, the recommendation engine 235 identifies content items from one or more sources 110 for recommending to a digital magazine server user. Hence, the recommendation engine 235 identifies content items potentially relevant to a user. In one embodiment, the recommendation engine 235 retrieves data describing interactions between a user and content items from the user's user profile and data describing connections between content items, and/or connections between users from the connection store 230 and generates a list of content items to recommend to the user. In one embodiment, the recommendation engine 235 uses stored information describing content items (e.g., topic, sections, subsections) and interactions between users and various content items (e.g., views, shares, saved, links, topics read, or recent activities) to identify content items that may be relevant to a digital magazine server user. For example, content items having an implicit connection of at least a threshold weight to a content item with which the user interacted are recommended to the user. As another example, the recommendation engine 235 presents a user with content items having one or more attributes in common with a content item with which an additional user having a threshold connection confidence score with the user interacted. Recommendations for additional content items may be presented to a user when the user views a content item using the digital magazine, may be presented as a notification to the user by the digital magazine server 140, or may be presented to the user through any suitable communication channel.

In one embodiment, the recommendation engine 235 applies various filters to content items received from one or more sources 110 or from the content store 215 to efficiently provide a user with recommended content items. For example, the recommendation engine 235 analyzes attributes of content items in view of characteristics of a user retrieved from the user's user profile. Examples of attributes of content items include a type (e.g., image, story, link, video, audio, etc.), a source 110 from which a content item was received, time when a content item was retrieved, and subject matter of a content item. Examples of characteristics of a user include biographic information about the user, users connected to the user, and interactions between the user and content items. In one embodiment, the recommendation engine 235 analyzes attributes of content items in view of a user's characteristics for a specified time period to generate a set of recommended content items. The set of recommended content items may be presented to the user or may be further analyzed based on user characteristics and on content item attributes to generate more refined set of recommended content items. A setting included in a user's user profile may specify a length of time that content items are analyzed before identifying recommended content items to the user, allowing a user to balance refinement of recommended content items with time used to identify recommended content items.

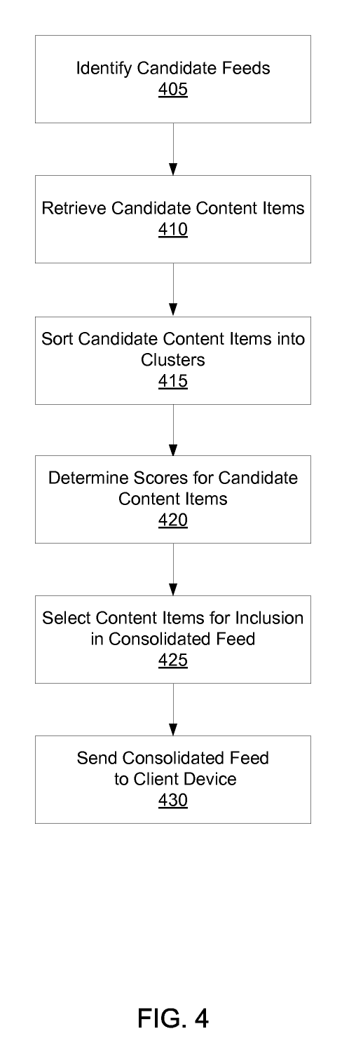

The recommendation engine 235 may identify content items for inclusion in a cover page that describes content items included in a section of a digital magazine. In one embodiment, a cover page includes information describing one or more content items included in a section of the digital magazine. To improve user interaction with the digital magazine server 140, the recommendation engine 235 may diversify the content items included in the cover page. As further described below in conjunction with FIG. 4, the recommendation engine 235 identifies candidate feeds each including one or more content items. The content items in a candidate feed may be retrieved from various sources 110, such as a social networking system a user has authorized the digital magazine server 140 to access, another entity providing content items for presentation to the user, the content store 215 (e.g., content items included in a section of the digital magazine that the user specified). Additionally, content items in a candidate feed may include content items that a source 110 or the digital magazine server 140 has targeted for presentation to users having one or more characteristics of the user or may include content items that the digital magazine server 140 has identified to be recommended to the user.

In one embodiment, the recommendation engine 235 retrieves various content items from different candidate feeds and generates clusters of similar content items based on characteristics of the retrieved content items. Content items having at least a threshold likelihood of being of interest to the user are selected from each cluster and included into a consolidated feed. Based on the consolidated feed, a cover page is generated that includes content items, or information describing content items, identified by the consolidated feed. If the candidate feeds from which the consolidated feed is generated are included in a specific cluster, or in clusters with a threshold similarity to each other, the consolidated feed is used to generate a cover page describing content items in a section of a digital magazine. For example, candidate feeds for hockey, baseball, and football are aggregated into a section cover page for sports.

The search module 240 receives a search query from a user and retrieves content items from one or more sources 110 based on the search query. For example, content items having at least a portion of an attribute matching at least a portion search query are retrieved from one or more sources 110. The user may specify sources 110 from which content items are received through settings maintained by the user's user profile or by identifying one or more sources in the search query. In one embodiment, the search module 240 generates a section of the digital magazine including the content items identified based on the search query, as the identified content items have a common attribute of their association with the search query. Presenting identified content items identified from a search query allows a user to more easily identify additional content items at least partially matching the search query when additional content items are provided by sources 110.

To more efficiently identify content items based on search queries, the search module 240 may index content items, groups (or sections) of content items, and user profile information. In one embodiment, the index includes information about various content items, such as author, source, topic, creation data/time, user interaction information, document title, or other information capable of uniquely identifying the content item. Search queries are compared to information maintained in the index to identify content items for presentation to a user. The search module 240 may present identified content items based on a ranking. One or more factors associated with the content items may be used to generate the ranking. Examples of factors include: global popularity of a content item among users of the digital magazine server 140, connections between users interacting with a content item and the user providing the search query, and information from a 110. Additionally, the search module 240 may assign a weight to the index information associated with each content item selected based on similarity between the index information and a search query and rank the content items based on their weights. For example, content items identified based on a search query are presented in a section of the digital magazine in an order based in part on the ranking of the content items.

To increase user interaction with the digital magazine, the interface generator 245 maintains instructions associating received input with actions performed by the digital magazine server 140 or by a digital magazine application executing on a client device 130. For example, instructions maintained by the interface generator 245 associate types of inputs or specific inputs received via an input device 134 of a client device 130 with modifications to content presented by a digital magazine. As an example, if the input device 134 is a touch-sensitive display, the interface generator 245 includes instructions associating different gestures with navigation through content items or presented via a digital magazine. Instructions from the interface generator 245 are communicated to a digital magazine application or other application executing on a client device 130 on which content from the digital magazine server 140 is presented. Inputs received via an input device 134 of the client device 130 are processed based on the instructions when content items are presented via the digital magazine server 140 is presented to simplify user interaction with content presented by the digital magazine server 140.

The web server 250 links the digital magazine server 140 via the network 120 to the one or more client devices 130, as well as to the one or more sources 110. The web server 250 serves web pages, as well as other content, such as JAVA®, FLASH®, XML and so forth. The web server 250 may retrieve content item from one or more sources 110. Additionally, the web server 250 communicates instructions for generating pages of content items from the layout engine 220 and instructions for processing received input from the interface generator 245 to a client device 130 for presentation to a user. The web server 250 also receives requests for content or other information from a client device 130 and communicates the request or information to components of the digital magazine server 140 to perform corresponding actions. Additionally, the web server 250 may provide application programming interface (API) functionality to send data directly to native client device operating systems, such as IOS®, ANDROID™, WEBOS® or BlackberryOS.

For purposes of illustration, FIG. 2 describes various functionalities provided by the digital magazine server 140. However, in other embodiments, the above-described functionality may be provided by a digital magazine application executing on a client device 130, or may be provided by a combination of the digital magazine server 140 and a digital magazine application executing on a client device 130. For example, content items may be recommended to the user by a digital magazine application executing on the client device 130, allowing content items to be recommended to the user by the client device 130. Alternatively, information identifying content items with which a user previously interacted is communicated from a client device 130 to the digital magazine server 140, which identifies content items to recommend to the user based at least in part on the identified content items and communicates one or more of the recommended content items to the client device 130.

### Page Templates

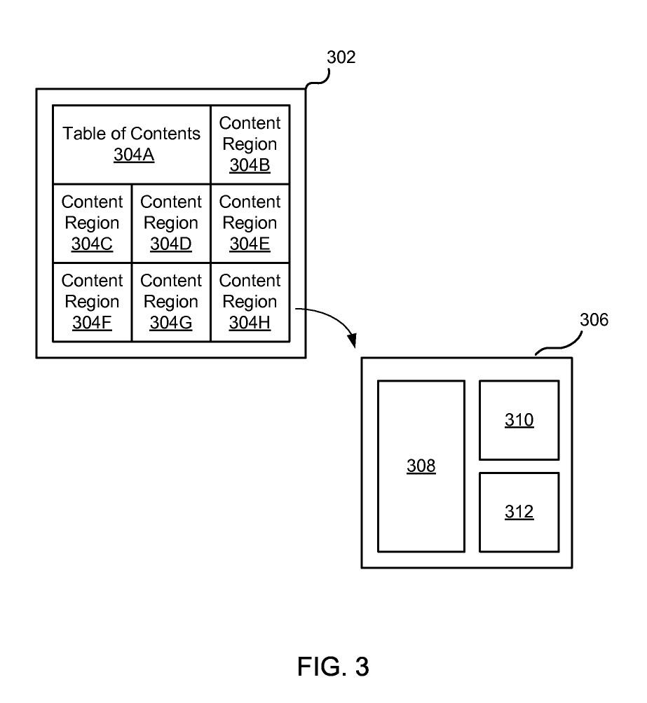

FIG. 3 illustrates an example page template 302 having multiple rectangular slots each configured to present a content item. Other page templates with different configurations of slots may be used by the digital magazine server 140 to present one or more content items received from sources 110. As described above in conjunction with FIG. 2, in some embodiments, one or more slots in a page template are reserved for presentation of content items having specific characteristics or for presentation of a specific type of content item. In one embodiment, the size of a slot may be specified as a fixed aspect ratio or using fixed dimensions. Alternatively, the size of a slot may be flexible, where the aspect ratio or one or more dimensions of a slot is specified as a range, such as a percentage of a reference or a base dimension. Arrangement of slots within a page template may also be hierarchical. For example, a page template is organized hierarchically, where an arrangement of slots may be specified for the entire page template or for one or more portions of the page template.

In the example of FIG. 3, when a digital magazine server 140 generates a page for presentation to a user, the digital magazine server 140 populates slots in a page template 302 with content items. Information identifying the page template 302 and associations between content items and slots in the page template 302 is stored and used to generate the page. For example, to present a page to a user, the layout engine 220 identifies the page template 102 from the template store 210 and retrieves content items from one or more sources 110 or from the content store 215. The layout engine 220 generates data or instructions associating content items with slots within the page template 302. Hence, the generated page includes various “content regions” presenting one or more content items associated with a slot in a location specified by the slot.

A content region 304 may present image data, text, data, a combination of image and text data, or any other information retrieved from a corresponding content item. For example, in FIG. 3, the content region 304A represents a table of contents identifying sections of a digital magazine, and content associated with the various sections are presented in content regions 304B-304H. For example, content region 304A includes text or other data indicating that the presented data is a table of contents, such the text “Cover Stories Featuring,” followed by one or more identifiers associated with various sections of the digital magazine. In one embodiment, an identifier associated with a section describes a characteristic common to at least a threshold number of content items in the section. For example, an identifier refers to the name of a user of social network from which content items included in the section are received. As another example, an identifier associated with a section specifies a topic, an author, a publisher (e.g., a newspaper, a magazine) or other characteristic associated with at least a threshold number of content items in the section. Additionally, an identifier associated with a section may further specify content items selected by a user of the digital magazine server 140 and organized as a section. Content items included in a section may be related topically and include text and/or images related to the topic.

Sections may be further organized into subsections, with content items associated with one or more subsections presented in content regions. Information describing sections or subsections, such as a characteristic common to content items in a section or subsection, may be stored in the content store 215 and associated with a user profile to simplify generation of a section or subsection for the user. A page template associated with a subsection may be identified, and slots in the page template associated with the subsection used to determine presentation of content items from the subsection relative to each other. Referring to FIG. 3, the content region 304H includes a content item associated with a newspaper to indicate a section including content items retrieved from the newspaper. When a user interacts with the content region 304, a page template associated with the section is retrieved, as well as content items associated with the section. Based on the page template associated with the section and the content items, the digital magazine server 140 generates a page presenting the content items based on the layout described by the slots of the page template. For example, in FIG. 3, the section page 306 includes content regions 308, 310, 312 presenting content items associated with the section. The content regions 308, 310, 312 may include content items associated with various subsections including content items having one or more common characteristics (e.g., topics, authors, etc.). Hence, a subsection may include one or more subsections, allowing hierarchical organization and presentation of content items by a digital magazine.

### Selecting Content Items for a Cover Page

FIG. 4 shows a flowchart of one embodiment of a method for selecting diverse content items for inclusion in a cover page of a digital magazine. In one embodiment, the functionality described in conjunction with FIG. 4 is provided by the recommendation engine 235; however, in other embodiments, any suitable component or combination of components may provide the functionality described in conjunction with FIG. 4. Additionally, in some embodiments, different and/or additional steps than those identified in FIG. 4 may be performed or the steps identified in FIG. 4 may be performed in different orders.

In one embodiment, the digital magazine server 140 identifies 405 candidate feeds of content items. A candidate feed includes one or more content items. For example, a candidate feed includes content items selected specifically for presentation to a particular user of the digital magazine server 140. Additionally, a candidate feed may include content items selected for presentation to users satisfying one or more criteria or may include content items for presentation to any user of the digital magazine server 140. Examples of candidate feeds including content items specific for a user include: content items in a section of a digital magazine defined by the user, content items from a social networking system account associated with the user, or content items recommended by the digital magazine server 140 for a user. A candidate feed may include content items from a source 110 to which the user provides compensation in exchange for receiving content items from the source 110. In some embodiments, the recommendation engine 235 identifies 405 the candidate feeds.

In one embodiment, a user-defined section of a digital magazine is stored in the content store 215 and may identify sources of content items from which content items in the user-defined section are retrieved. Examples of sources of content items identified in a user-defined section include: a digital magazine, a news source, an external content provider (e.g., a website or other content provider), a content aggregator, or a rich site summary (RSS) feed. Content items may be obtained from sources of content items based on a user's subscription to a source of content items, where the user compensates the source of the content item for access to the content items. The sources of content items may include publicly accessible content items. One example user-defined section in a digital magazine focuses on over-hyped quarterbacks in a professional football league. User-defined sections may be populated with content items retrieved by the search module 240 according on one or more search terms. For example, a user enters the search terms “Tim Tebow” and “interception,” and the search module 240 returns content items satisfying one or more of the search terms.

The digital magazine server 140 may identify 405 candidate feeds from social media feeds, which include content items from one or more social networking systems associated with a user profile of a digital magazine server user. The user may provide the digital magazine server 140 with authorization to access one or more of the social networking systems. For example, the user provides the digital magazine server 140 with access credentials such as a username and password. Alternatively or additionally, the user may authorize the digital magazine server 140 access to the social networking system by identifying to the social networking system that the digital magazine server 140 is authorized to access information associated with the user; the social networking system 140 may then communicate the digital magazine server 140 an access key or code. The digital magazine server 140 retrieves user-generated content items from the social networking system and incorporates the received one or more content items for presentation to the user by the social networking system into a social media feed.

The digital magazine server 140 may also identify 405 candidate feeds based on recommended content items. In one embodiment, the recommendation engine 235 uses connections between a user and content items to identify content items for recommendation to the user. The digital magazine server 140 records users' interactions with content items in the user profile store 205 and may generate weighted connections between various users and content items based on these interactions, which are stored by the digital magazine server 140. Some connections may be associated with inferred weights that may be used to infer a user's interests from the connections, allowing the digital magazine server 140 to recommend content items to a user based on the inferred user interests. When a connection between a user and a content item with which the user has not previously interacted has a weight equaling or exceeding a threshold value, the content item is recommended to the user. For example, a user views numerous content items showing interceptions in football games. Based on interactions from other users, the digital magazine server 140 infers connections between content items showing interceptions and content items showing Tim Tebow playing football. Hence, the digital magazine server 140 infers a connection between the user and the content items showing Tim Tebow playing football. The content items showing Tim Tebow playing football are identified 405 for inclusion in the content feed if the connections have at least a threshold weight.

Additionally, the digital magazine server 140 may identify 405 candidate feeds including content items for presentation to multiple digital magazine server users. A candidate feed may include content items for presentation to users having one or more characteristics. Characteristics include user characteristics, which are attributes of a user retrieved from a corresponding user profile in the user profile store 205. Example user characteristics include age, gender, geographic location, income, and other demographic information. Characteristics also include device characteristics, which are attributes of the hardware and/or software of the client device 130 with which the user accesses the digital magazine server 140. Example device characteristics include a type of the client device 130 (e.g., tablet, mobile phone, laptop), a make or model of the client device 130, software executing on the client device (e.g., operating system, browser), a version of an application used to access the digital magazine server 140, and characteristics of a display device 132 of the client device 130. In one embodiment, the digital magazine server 140 infers that users having a particular set of characteristics are interested in one or more content items, so these content items are incorporated into a candidate feed for presentation to users having at least a threshold number of characteristics in the set. Alternatively or additionally, content items are manually selected for incorporation into a candidate feed for presentation to users having one or more characteristics. An example candidate feed for presentation to users having at least a threshold number of characteristics in a set of characteristics includes content items showing Tim Tebow fumbling a football and identifies a set of characteristics that identify male users between the ages of twenty and sixty who live outside of Florida to be presented with the content items. As another example, a candidate feed includes content items having a mobile version suitable for display on a small display device 132 for presentation to users associated with a mobile device or using an application executing on a mobile device to access the digital magazine server 140.

The digital magazine server 140 may also identify 405 candidate feeds applicable to a broad range of users. In one embodiment, a set of candidate feeds are defined that each include content items associated with particular categories (e.g., local news, national news, world news, sports, entertainment). For example, a candidate feed includes featured stories chosen by an editor of the digital magazine server 140 or by an external entity for presentation to various digital magazine server users.

Based on the identified candidate feeds, the digital magazine server 140 retrieves 410 candidate content items. In one embodiment, the retrieved content items are stored in the content store 215 of the digital magazine server. Content items from one or more candidate feeds may be retrieved 410 as candidate content items based on various characteristics of the content items. For example, content items provided to the digital magazine server 140 are retrieved 410 as candidate content items. As another example, content items are retrieved 410 as candidate content items based on candidate feeds including the content items. The retrieved candidate content items are evaluated for inclusion in a cover page describing content items in a digital magazine or inclusion in a section of a digital magazine. In an alternative embodiment, content items are retrieved from one or more sources 110. In one embodiment, the online system 140 applies filters to the retrieved content items to limit content items retrieved 410 as candidate content items. In various embodiments, content items may be filtered from retrieval as candidate content items evaluated for inclusion in a cover page based on the content items' time of publication. For example, the digital magazine server 140 retrieves 410 news articles from the content store 215 associated with a time that is within a threshold duration of a current time (e.g., 24 hours) as candidate content items because a news articles may be relevant to a user for a short period of time. Additionally, content items may be filtered from retrieval as candidate content items evaluated for inclusion in a cover page based on obscenity or age relevance to users of the digital magazine server 140. For example, content items relating to Bill Belichick's views on morality are excluded from presentation on cover pages presented to users less than eighteen years old.

The retrieved candidate content items are sorted 415 into one or more clusters based at least in part on the content elements of the candidate content items. Content elements included in a content item include text data, image data, video data, links to sources, interactive media, audio data, or any other suitable information. Generally, sorting 415 content items into clusters produces various clusters including content items associated with a common topic or associated with similar topics. In one embodiment, vectors representing the candidate content items are generated based on topics identified form the candidate content items and the candidate content items are sorted 415 based on sorting the vectors representing the candidate items. Topics are key terms and/or phrases associated with a candidate content item. In some embodiments, topics are included in metadata associated with candidate content items (e.g., hashtags). In some embodiments, topics are identified using content elements of the candidate content item. Topics may be identified based the frequency with which terms or phrases appear in content elements or based on the presentation of various words or phrases relative to other words or phrases. In various embodiments, words may be grouped into phrases for identifying topics based on an external reference or based on repeated proximity in a candidate content item or in various candidate content items. For example, a content item about Tim Tebow may correspond to the topics “Tim Tebow,” “University of Florida,” and “quarterback.” Additionally, topics may be determined based on video captions, categories, titles, photo titles, or photo captions. Based on topics identified from a candidate content item, the digital magazine server 140 generates a vector describing the candidate content item. In various embodiments, the vector has at least as many dimensions as the number of associated topics, and the weight of each dimension may be based in part on the number of times a topic occurs in the candidate content item, or where the topic occurs in the candidate content item.

Alternatively or additionally, vectors are generated based on the content elements in a content item without generating topics. For example, a vector is generated having dimensions corresponding to words in the content item, where common words such as articles, conjunctions, and prepositions are omitted. The weighting of each dimension in the vector may be based on the number of occurrences in a content item or across content items, location of a word in a candidate content item (e.g., headline, sub-headline, body text, category), or emphasis on the word (e.g., underlining, bolding, italicizing, linking to an external page, different coloration from other text) in a candidate content item. For example, the weighting of a dimension of the vector is determined using a function that increases at a rate that decreases as a number of occurrences of the word in the candidate content item increases. Other content elements of candidate content items may be used to generate a vector describing a candidate content item. For example, two candidate content items having a similar image have a similar weight in the dimension of their respective vectors corresponding to that image. As another example, portions of video data included in a candidate content item are identified and associated with a dimension of the vector. Two content items having the same portion of a video may have differing weights in a of a vector dimension corresponding to the video clip based on the duration of the portion of the video presented by each of the content items.

The vectors representing the candidate content items are sorted 415 into clusters using one or more standard clustering techniques (e.g., K-means, expectation-maximization, density-based clustering techniques). Hence, content items relating to similar topics are grouped into a common cluster. For example, if a candidate feed includes content items about football, football stories about Peyton Manning, Bill Belichick, and stories about the man formerly known as Chad Ochocinco, these candidate content items would be sorted 415 into separate clusters for each identified person. Generating vectors associated with content items and clustering content items based on the vectors is further described in U.S. patent application Ser. No. 14/164,089, filed on Jan. 24, 2014, which is hereby incorporated by reference in its entirety.

Scores for the candidate content items are determined 420 based on the user. In one embodiment, a score for a candidate content item is determined 420 based on a weight associated with a connection between the user and the candidate content item by the digital magazine server 140. Alternatively, a score for a content item is determined 420 based on a characteristic vector for a cluster including the candidate content item. The characteristic vector for a cluster is based at least in part on vectors describing one or more candidate content items in the cluster. For example, the characteristic vector for a cluster is a mean of the vectors in the cluster. The score of a candidate content item may be determined 420 based on a measure of similarity between the vector corresponding to the candidate content item and a characteristic vector of the cluster including the candidate content item. Example measures of similarity include cosine similarity or the generalized Euclidean distance between a vector and the characteristic vector. Alternatively or additionally, a score for a candidate content item is determined 420 by comparing the vector representing the candidate content item to a characteristic vector based on previous interactions of the user with content items as described above. In one embodiment, a composite score is determined 420 for a candidate content item from a combination of a score based on connection weights, a score based on similarity to other candidate content items in a cluster including the candidate content item, and a score based on similarity to a characteristic vector of the cluster including the candidate content item. Additional scores, such as a score representing previous user interactions with the candidate content item, may be used in addition to the previously described scores or in place of one or more of the previously described scores to determine 420 the composite score for the candidate content item.

Based on the determined scores and the clusters including various candidate content items, candidate content items from a plurality of clusters are selected 425 for inclusion in a consolidated feed. For example, at least candidate one content item from each of the clusters is selected 425 for inclusion into the consolidated feed. In some embodiments, a candidate content item having a maximum score relative to scores of candidate content items in a cluster is selected 425 for inclusion in the consolidated feed. Alternatively, candidate content items are selected 425 from at least a threshold number of different clusters for inclusion in the consolidated feed based on the determined scores. In one embodiment, the candidate content items in a cluster are ranked based on the determined scores, and at least one content item having a threshold position in the ranking is selected 425 from the cluster. For example, the candidate content items in a cluster are ranked by measures of similarity between the candidate content items and a characteristic vector representing the cluster. In the example, the content item having the highest measure of similarity (e.g., lowest generalized Euclidean distance from the characteristic vector) is selected 425. Alternatively or additionally, the candidate content items in a cluster that have at least a threshold score are selected 425 for inclusion in the consolidated feed. In other embodiments, the digital magazine server 140 ranks candidate content items in a cluster based on their associated scores and selects 425 candidate content items from the cluster having at least a threshold position in the ranking for inclusion in the consolidated feed. Hence, the consolidated feed includes stories suitable for identification via a cover story that provides a representation of the content included in various clusters.

In one embodiment, content items included in the consolidated feed are again sorted 415 into clusters and scores are determined 420 for the content items included in the consolidated feed, and a subset of the content items included in the consolidated feed are selected 425 for inclusion into a further consolidated feed based on the clusters and the scores, as described above. This consolidation of content items may continue until one or more conditions are satisfied. For example, conditions may be based on the scores, relevance to the user, diversity, and/or the number of selected content items. A condition may specify that a threshold number of content items from different candidate feeds are included in the consolidated feed presented to the user present or that content items from at least a threshold number of candidate feeds are included in the. For example, conditions may specify that three content items from social media feeds are present in the consolidated feed along with three content items recommended for a user and six content items from one or more sources 110.

In one embodiment, there are a plurality of consolidated feeds generated by the digital magazine server 140, with candidate content items selected 425 for inclusion into a particular consolidated feed based on a measure of similarity between a candidate content item and other content items in the particular consolidated feed (e.g., an average cosine similarity or the generalized Euclidean distance between a vector for a candidate content item and vectors for various candidate content items in the particular consolidated feed). The particular consolidated feeds allow further consolidation of candidate content items. For example, the particular consolidated feeds may represent cover pages for various sections of a digital magazine associated with different topics or subjects. For example, candidate feeds for a user variously include content items associated with hockey, baseball, Germany, Ghana, and Portugal. Content items from the hockey and baseball candidate feeds are selected for inclusion into a further consolidated feed including content items relating to sports, and content items from the candidate feeds about Germany, Ghana, and Portugal are selected for inclusion into an additional further consolidated feed about world news. Content items included in the further consolidated feed and in the additional further consolidated feed may be combined to form one or more consolidated feeds describing overall content of a digital magazine.

Hence, the consolidated feeds may be hierarchically organized to describe varying numbers of content items for different sections of a digital magazine. This hierarchical organization may include any number of levels of consolidated feeds representing cover pages of sections or subsections within a digital magazine. In one embodiment, the digital magazine server 140 uses heuristics to determine which consolidated feeds are further combined. These heuristics may seek to replicate a desired tone of the cover page. Heuristics may ensure diversity in content items included in a consolidated feed or in a further consolidated feed by combining consolidated feeds based at least in part on characteristics of content items in the consolidated feeds. For example, consolidated feeds having similar topics or subjects are combined into a further consolidated feed to allow inclusion of content items from alternative consolidated feeds having different topics or subjects in content presented to a user, increasing (e.g., a cover page of a digital magazine) diversity of the content provided to the user. Heuristics may also be based on relevance to user. For example, consolidated feeds including content items with less than a threshold likelihood of relevance to the user are combined or are discarded from inclusion in content based on the consolidated feeds. Other heuristics may enforce quotas for certain types of content (e.g., a minimum number of news stories, sports stories, featured stories, or social media content items) presented to the user via the digital magazine server 140.

The consolidated feed (or further consolidated feeds) are sent 430 to a client device 130 associated with the user for display (e.g., on the display device 132). The content items in the consolidated feed may be presented as a portion of a digital magazine provided by the digital magazine server 140. For example, the consolidated feed is presented as a cover page, a table of contents, a section cover page, or a sub-section cover page. In one embodiment, the content items in the consolidated feed are evaluated for a measure of similarity to each other, and content items in the consolidated feed having at least a threshold measure of similarity to each other are arranged to be proximate to each other within the consolidated feed so that similar content items within the consolidated feed are displayed in proximity to each other. The measure of similarity between content item within the consolidated feed may be determined as describe above or may be determined by comparing content elements of various content items describing appearance of the content items. Information describing positioning of the content items in a consolidated feed relative to each other is sent 430 to the client device 130 along with the consolidated feed. In one embodiment, the digital magazine server 140 selects a stored page template based on characteristics of the client device 130 or display device 132 and associates content items in the consolidated feeds with slots in the page templates based on content elements in the content items, characteristics of the user, prior user interactions with content, user preferences for content, similarity between content items in the consolidated feed, promotional considerations, or other factors. The selected page template and associations between content items in the candidate feed and slots in the selected page template is sent 430 to the client device 130 along with the consolidated feed, so the client device 130 presents content items within the feed in positions relative to each other specified by the slots in the selected page template. The displayed cover page may present previews of content items included in consolidated feeds positioned relative to each other based on slots in the page template. A preview of a content item may include a headline, a title, a summary, an image, an animation, or any other content element from the content item.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for recommending content items to a user of a digital magazine server, the method comprising:
identifying a plurality of candidate feeds based on the user, each candidate feed comprising one or more content items each having content elements;
retrieving candidate content items from the one or more content items in each of the candidate feeds;
sorting the candidate content items into one or more clusters of content items based at least in part on the content elements of the candidate content items;
determining scores of the candidate content items based at least in part on characteristics of the user and the content elements of the candidate content items;
selecting content items for inclusion into a consolidated feed from the candidate content items based at least in part on the determined scores and the clusters, the consolidated feed including candidate content items from a plurality of clusters; and
sending the consolidated feed to a client device for presentation to the user via a digital magazine provided by the digital magazine server.

2. The method of claim 1, wherein selecting content items for inclusion into the consolidated feed from the candidate content items based at least in part on the determined scores and the clusters comprises:
selecting at least one candidate content item from each cluster for inclusion in the consolidated feed based at least in part on the determined scores.

3. The method of claim 2, wherein selecting at least one candidate content item from each cluster for inclusion in the consolidated feed based at least in part on the determined scores comprises:
for each cluster, selecting a candidate content item having a maximum score within a cluster for inclusion in the consolidated feed.

4. The method of claim 1, wherein selecting content items for inclusion into the consolidated feed from the candidate content items based at least in part on the determined scores and the clusters comprises:
selecting at least one candidate content item from at least a threshold number of clusters for inclusion in the consolidated feed based at least in part on the determined scores.

5. The method of claim 1, wherein sending the consolidated feed to the client device for presentation to the user via the digital magazine provided by the digital magazine server comprises:
determining measures of similarity between pairs of content items within the consolidated feed;
determining positions of content items within the consolidated feed relative to each other based at least in part on the measures of similarity; and
sending the consolidated feed including information specifying positions of content items within the feed relative to each other to the client device for presentation to the user.

6. The method of claim 1, wherein sending the consolidated feed to the client device for presentation to the user via the digital magazine provided by the digital magazine server comprises:
selecting a page template maintained by the digital magazine server, the page template including one or more slots, each slot associated with a position and configured to present a content item;
associating content items included in the consolidated feed with slots included in the page template; and
sending the consolidated feed, the page template, and the associations between content items included in the consolidated feed with slots included in the page template to the client device for presentation.

7. The method of claim 6, wherein the associating content items included in the consolidated feed with slots included in the page template is based at least in part on one or more selected from a group consisting of: content elements included in various content items included in the consolidated feed, characteristics of the user, and any combination thereof.

8. The method of claim 1, wherein a candidate feed is selected from a group consisting of: content items selected for presentation to the user, content items selected for presentation to one or more digital magazine server users satisfying one or more criteria, content items selected for presentation to any user of the digital magazine server, and any combination thereof.

9. The method of claim 1, wherein sending the consolidated feed to the client device for presentation to the user via the digital magazine provided by the digital magazine server comprises:
sorting content items included in the consolidated feed into one or more clusters based at least in part on content elements of the content items included in the consolidated feed;
determining scores of the content items included in the consolidated feed, a score for a content item included in the consolidated feed based at least in part on characteristics of the user and content elements of the content item included in the consolidated feed;
selecting content items for inclusion into a further consolidated feed from the content items included in the consolidated feed based at least in part on the determined scores of the content items included in the consolidated feed and the clusters including content items included in the consolidated feed; and
sending the further consolidated feed to the client device for presentation to the user.

10. The method of claim 1, wherein sorting the candidate content items into one or more clusters of content items based at least in part on the content elements of the candidate content items comprises:
generating one or more topics associated with each of the candidate content items, the one or more topics associated with a candidate content item based at least in part on the content elements of the candidate content item;
generating a vector for each candidate content item, the vector for the candidate content item based at least in part on the one or more topics associated with the candidate content item, the vector having one or more dimensions each associated with a topic associated with the candidate content item; and
generating the one or more clusters based at least in part on the generated vectors.

11. A computer program product comprising a computer readable storage medium having instructions encoded thereon that, when executed by a processor, cause the processor to:
identify a plurality of candidate feeds based on the user, each candidate feed comprising one or more content items each having content elements;
retrieve candidate content items from the one or more content items in each of the candidate feeds;
sort the candidate content items into one or more clusters of content items based at least in part on the content elements of the candidate content items;
determine scores of the candidate content items based at least in part on characteristics of the user and the content elements of the candidate content items;
select content items for inclusion into a consolidated feed from the candidate content items based at least in part on the determined scores and the clusters, the consolidated feed including candidate content items from a plurality of clusters; and
send the consolidated feed to a client device for presentation to the user via a digital magazine provided by the digital magazine server.

12. The computer program product of claim 11, wherein select content items for inclusion into the consolidated feed from the candidate content items based at least in part on the determined scores and the clusters comprises:
select at least one candidate content item from each cluster for inclusion in the consolidated feed based at least in part on the determined scores.

13. The computer program product of claim 12, wherein select at least one candidate content item from each cluster for inclusion in the consolidated feed based at least in part on the determined scores comprises:
for each cluster, select a candidate content item having a maximum score within a cluster for inclusion in the consolidated feed.

14. The computer program product of claim 11, wherein select content items for inclusion into the consolidated feed from the candidate content items based at least in part on the determined scores and the clusters comprises:
select at least one candidate content item from at least a threshold number of clusters for inclusion in the consolidated feed based at least in part on the determined scores.

15. The computer program product of claim 11, wherein send the consolidated feed to the client device for presentation to the user via the digital magazine provided by the digital magazine server comprises:
determine measures of similarity between pairs of content items within the consolidated feed;
determine positions of content items within the consolidated feed relative to each other based at least in part on the measures of similarity; and
send the consolidated feed including information specifying positions of content items within the feed relative to each other to the client device for presentation to the user.

16. The computer program product of claim 11, wherein send the consolidated feed to the client device for presentation to the user via the digital magazine provided by the digital magazine server comprises:
select a page template maintained by the digital magazine server, the page template including one or more slots, each slot associated with a position and configured to present a content item;
associate content items included in the consolidated feed with slots included in the page template; and
send the consolidated feed, the page template, and the associations between content items included in the consolidated feed with slots included in the page template to the client device for presentation.

17. The computer program product of claim 16, wherein associate content items included in the consolidated feed with slots included in the page template is based at least in part on one or more selected from a group consisting of: content elements included in various content items included in the consolidated feed, characteristics of the user, and any combination thereof.

18. The computer program product of claim 11, wherein a candidate feed is selected from a group consisting of: content items selected for presentation to the user, content items selected for presentation to one or more digital magazine server users satisfying one or more criteria, content items selected for presentation to any user of the digital magazine server, and any combination thereof.

19. The computer program product of claim 11, wherein send the consolidated feed to the client device for presentation to the user via the digital magazine provided by the digital magazine server comprises:
sort content items included in the consolidated feed into one or more clusters based at least in part on content elements of the content items included in the consolidated feed;
determine scores of the content items included in the consolidated feed, a score for a content item included in the consolidated feed based at least in part on characteristics of the user and content elements of the content item included in the consolidated feed;
select content items for inclusion into a further consolidated feed from the content items included in the consolidated feed based at least in part on the determined scores of the content items included in the consolidated feed and the clusters including content items included in the consolidated feed; and
send the further consolidated feed to the client device for presentation to the user.

20. The computer program product of claim 11, wherein sort the candidate content items into one or more clusters of content items based at least in part on the content elements of the candidate content items comprises:
generate one or more topics associated with each of the candidate content items, the one or more topics associated with a candidate content item based at least in part on the content elements of the candidate content item;
generate a vector for each candidate content item, the vector for the candidate content item based at least in part on the one or more topics associated with the candidate content item, the vector having one or more dimensions each associated with a topic associated with the candidate content item; and
generate the one or more clusters based at least in part on the generated vectors.
